(19) United States
(12) Patent Application Publication
(10) Pub. No.: US 2021/0233367 A1
(43) Pub. Date: Jul. 29, 2021

(54) NOZZLE GAS FLOW SENSOR

(71) Applicant: Nasarc Technologies Inc., Waterloo (CA)

(72) Inventor: Jody RICE, Waterloo (CA)

(21) Appl. No.: 16/972,435

(22) PCT Filed: May 31, 2019
(86) PCT No.: PCT/CA2019/050757

§ 371 Date: Dec. 4, 2020

(30) Foreign Application Priority Data
Jun. 4, 2018 (CA) 3007201

(51) Int. Cl. G08B 5/38; G01F 15/06; G01F 15/12; G01F 15/14; G05B 13/02

(52) U.S. Cl. CPC G08B 5/38; G01F 15/068; B23K 9/164; G01F 15/14; G05B 13/0265; G01F 15/125

(57) ABSTRACT

A nozzle gas flow sensor and a method thereof are provided. The nozzle gas flow sensor includes circuitry configured to receive sensing signals (readings) from a sensing element, each indicative of a flow rate of shielding gas ejected from a nozzle of a torch; analyze the flow rate; and evaluate the stability of the flow rate of the shielding gas with a window of operation. The nozzle gas flow sensor may include an indicator indicative of the evaluation result. The torch may be a welding torch, a cutting torch and/or a spraying (coating) torch.

### FIELD OF INVENTION

The present invention generally relates to nozzle gas flow sensing systems and methods, and more particularly to evaluating stability of gas flow ejected from a gas nozzle.

### BACKGROUND

Torches are widely used in various welding applications, including arc welding, cutting and spraying (coating). For example, in metal inert gas (MIG) welding, an electric arc is formed between a consumable electrode fed through a torch nozzle and a workpiece. In tungsten inert gas (TIG) welding, an electric arc is generated between a non-consumable electrode (tungsten) fed through a torch nozzle and a workpiece. In plasma arc welding, a plasma arc is formed using a constricting nozzle in a torch, which may be operated in a transferred arc process mode or a non-transferred arc process mode. In plasma cutting, a plasma arc is formed between an electrode placed in a plasma torch nozzle and a workpiece. In plasma spraying, a plasma arc is formed between an electrode and a constricting nozzle in a plasma torch, and coating material injected into a high temperature plasma flame is sprayed over a substrate to be coated. In such welding, cutting and/or spraying operations, shielding gas flow is generated by the torch to protect the arc and weld area and/or coating materials from atmospheric contamination. Stability of the gas flow is therefore a key factor of the efficiency and quality of the welding, cutting and spraying. There is a need to provide a tool to monitor and analyze the shielding gas flow from a torch nozzle.

### SUMMARY

According to an aspect of the disclosure there is provided a nozzle gas flow sensor, which includes: circuitry configured to: receiving sensor readings from a sensing element, each reading indicative of a flow rate of shielding gas ejected from a nozzle of a torch; and evaluating the stability of the flow rate of the shielding gas with a window of operation based on the sensor readings to output the evaluation result indicative of stable gas flow within the window of operation.

According to another aspect of the disclosure there is provided a method in a nozzle gas flow sensor, which includes: receiving sensor readings from a sensing element, each reading indicative of a flow rate of shielding gas ejected from a nozzle of a torch; and evaluating stability of the shielding gas within a window of operation based on the sensor readings to output the evaluation result indicative of stable gas flow within the window of operation.

According to a further aspect of the disclosure there is provided a non-transitory computer readable medium storing instructions, which when executed by a computer cause the computer to execute a method including: receiving sensor readings from a sensing element, each reading indicative of a flow rate of shielding gas ejected from a nozzle of a torch; and evaluating stability of the shielding gas with a window of operation based on the sensor readings to output the evaluation result indicative of stable gas flow within the window of operation.

### BRIEF DESCRIPTION OF THE DRAWINGS

These and other features of the disclosure will become more apparent from the following description in which reference is made to the appended drawings wherein:

FIG. 1 illustrates one embodiment of a nozzle gas flow sensor (NGFS);

FIG. 2A illustrates one example of setting a window of operation;

FIG. 2B illustrates another example of setting a window of operation;

FIG. 3 illustrates another embodiment of NGFS;

FIG. 4 illustrates one embodiment of a gas flow analysis process;

FIG. 5 illustrates another embodiment of a gas flow analysis process;

FIG. 6 illustrates a further embodiment of a gas flow analysis process;

FIG. 7 illustrates a further embodiment of a controller in NGFS;

FIG. 8 illustrates a further embodiment of NGFS;

FIG. 9 illustrates a plug for the housing of NGFS shown in FIG. 8;

FIG. 10 illustrates a nozzle and NGFS shown in FIG. 8 where a housing cover is removed;

FIGS. 11A and 11B illustrate robotic equipment on which NGFS shown in FIG. 8 is mounted; and

FIG. 12 illustrates a schematic view of an exemplary combination of a torch and NGFS.

### DETAILED DESCRIPTION

Various embodiments are generally directed to nozzle gas flow sensing systems, methods and applications thereof, which are described in detail below by way of example. The nozzle gas flow sensing described herein may be used for welding, cutting and/or spraying (coating) torches in automatic, semi-automatic and/or manual operations. The examples and figures are illustrative only and not limit the invention.

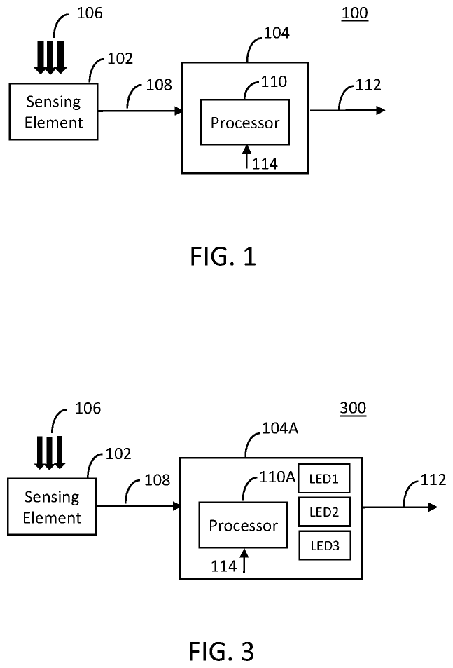

Referring to FIG. 1, a nozzle gas flow sensor (NGFS) 100 is described. In the illustrated embodiment, NGFS 100 includes a sensing element 102 and a controller 104. The sensing element 102 measures a flow rate (or a flow velocity) of gas 106 and outputs a sensing signal 108 (sensor reading) indicative of the flow rate of the gas. The gas flow rate is, for example, a value calculated from a mass flow rate in a specific diameter wind tunnel. In this disclosure, the terms “flow rate” and “flow velocity” are used interchangeably. In the illustrated embodiment, the sensing element 102 is included in NGFS 100; however the sensing element 102 may be located external to NGFS 100. The gas to be monitored by the sensing element 102 is, for example, emitted from a gas nozzle of a torch (not shown in FIG. 1).

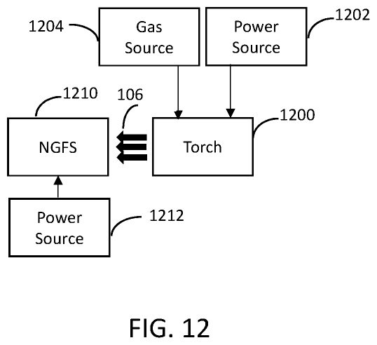

NGFS 100 may have a receiving member (not shown in FIG. 1) to receive and position the gas nozzle so that the sensing element 102 accurately measures the flow rate of gas 106 emitted from the gas nozzle. The receiving member may be replaceable depending on the size of the torch. The torch may be a consumable or non-consumable electrode type torch, such as a MIG or TIG torch, a plasma torch for welding, cutting and/or coating of workpieces. For example, the torch (e.g., 1200 shown in FIG. 12) may be connected to a wire feeding mechanism, a power generator (e.g., 1202 shown in FIG. 12) for generating an arc with a workpiece and a shielding gas source (e.g., 1204 shown in FIG. 12) for providing shielding gas. The torch may be linked to various components for welding/cutting/spraying operations, such as hard or fixed automation components, programmable automation components, flexible automation components, manual components, which may be fully or partially automated. NGFS 100 may communicate with such welding/cutting/spraying components.

The controller 104 generally controls the operation of NGFS 100. In particular the controller is configured to monitor and analyze the gas flow 106 rate within a window of operation. The controller may be configured to activate any of functions in the controller at a programmed or predetermined timing, which may be adjustable. The controller may be configured to start analyzing the gas flow 106 rate at a programmed or predetermined timing, which may be adjustable. The controller may be configured so that the operation for analyzing the gas flow 106 rate is manually initiated or adjusted. In one example, the controller 104 may include one or more microprocessors, which may be implemented on a programmable circuit board (PCB). In another example, the controller 104 may be implemented by analog circuitry or a combination of analog and digital circuits. In the illustrated embodiment, the controller 104 includes a processor 110 configured to process the sensing signal 108, evaluate stability of the gas flow 106 within a window of operation based on the sensing signal 108, and outputs one or more evaluation results. The setting of the window of operation may be adjusted in various ways. The processor 110 may execute any instructions other than those described and illustrated herein.

The controller 104 provides an output 112. The output 112 includes one or more evaluation signals which represent one or more evaluation results. The evaluation signal may include a “on” or “off” signal indicative of stable gas flow during a window of operation. The output 112 may be used to automatically or manually adjust the gas nozzle or operational setting of the shielding gas from the gas nozzle. The controller 104 may include one or more visual status indicators (e.g., light-emitting diodes (LEDs)) and/or audio status indicators for manual operation as described below. These indicators may be operated based on the output 112. The visual indicators and/or audio status indicators may be mounted on the controller's PCB.

The controller 104 may receive one or more teach inputs 114. The one or more teach inputs 114 may include, for example, a command to operate NGFS 100. The teach inputs 114 may be enabled/activated through external input terminals of NGFS 100 (not shown) and/or may be manually enabled/activated through an operation tool, such as push or pull buttons, potentiometer knobs, switches.

NGFS 100 may include one or more memories (not shown in FIG. 1). The memory may reside in the controller 104 or external to the controller 104. The one or more memories may store instructions that cause elements of NGFS 100 to operate. The one or more memories may be also used to store the sensing signal 108, the output 112, the teach inputs 114, and/or associated data. One or more of the teach inputs 114 may be used to store current reading (sensing) data of the sensing element 102, the output 112 and/or associated data, in the memory.

In one example, NGFS 100 is a stand-alone device, and NGFS 100 may be connectable with automation equipment for operating gas equipment, such as fully or semi-automated robots, programmable logic computers (PLCs), or other devices. In a further example, NGFS 100 may be detachably connected to external equipment. In a further example, NGFS 100 may be installed or integrated onto equipment such as a robotic torch cleaner (e.g., Intelliream™ by Nasarc technologies Inc.), a torch maintenance center (e.g., Welding Torch Maintenance Center™ by Nasarc technologies Inc.).

NGFS 100 may have a housing (not shown in FIG. 1) for accommodating one or more elements of NGFS 100. In one example, the housing may be designed to accommodate the sensing element 102 and the controller 102. In another example, the controller 102 may be mounted on the housing while the sensing element 102 may be remotely mounted outside the housing, for example, using an extension hose, pipe, or similar conduit to direct the gas flow. In a further example, the sensing element 102 may be mounted on the housing while the controller 104 may be remotely mounted outside the housing, for example, using an extension cable to electrically communicate with the sensing element or other elements in the housing. The receiving member for receiving a gas nozzle may be mounted on the housing. The housing may have a removable mounting bracket so that the housing is attached to external equipment.

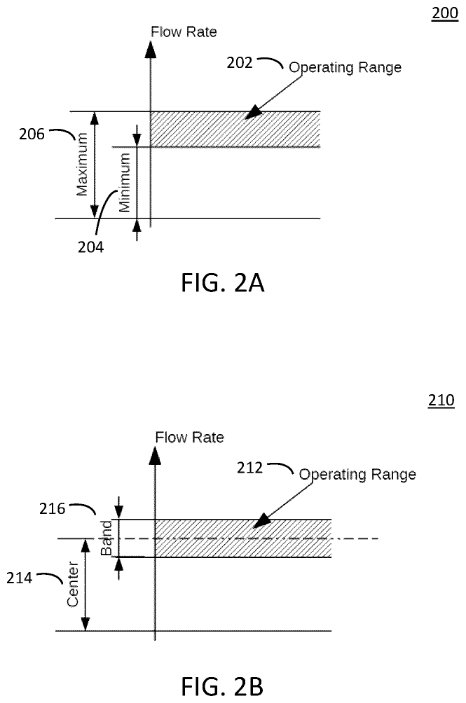

Referring to FIG. 2A, one example of a window of operation (“200”) is described in detail. The window of operation 200 has an operating range 202 defining the evaluation range of a gas flow rate. In this illustrated embodiment, the operation range 202 is defined by at least two parameter values: a minimum flow rate 204 and a maximum flow rate 206. Using these values 204 and 206, a tolerance band between the minimum flow rate 204 and the maximum flow rate 206 and a setpoint of the tolerance band can be calculated. The “setpoint” herein refers to a center point of the tolerance band, and the terms “center point” and “setpoint” are used interchangeably in the disclosure. By changing these values 204 and 206, the tolerance band and the center point of the tolerance band are also adjusted.

Referring to FIG. 2B, another example of the window of operation (“210”) is described in detail. The window of operation 200 has an operating range 212 defining an evaluation range of a gas flow rate. In this illustrated embodiment, the operation range 212 is defined by at least two parameter values: a center point (setpoint) 214 and a tolerance band 216. Using these values 214 and 216, a minimum flow rate and a maximum flow rate of the tolerance band 216 can be calculated. By changing these band values 214 and 216, the minimum flow rate and the maximum flow rate of the tolerance band are also adjusted.

Referring to FIGS. 1, 2A and 2B, a window of operation may be adjusted manually or automatically using external signals. In one example, the minimum flow rate 204, the maximum flow rate 206, the center point 214, and/or the tolerance band 216 may be adjusted using one or more manual tools. In another example, the minimum flow rate 204, the maximum flow rate 206, the center point 214, and/or the tolerance band 216 may be adjusted based on the one or more teach inputs 114.

Referring to FIG. 3, NGFS 300 is described in detail. NGFS 300 is similar to NGFS 100 shown in FIG. 1. NGFS 300 includes a controller 104A having a processor 110A. The controller 104A and the processor 110A are similar to the controller 104 and the processor 110 shown in FIG. 1. The sensing element 102 may be located in NGFS 300 or external to NGFS 300. NGFS 300 is configured to communicate stable gas flow to an operator for welding/cutting/spraying operations, via a plurality of visual status indicators for manual operation. In the illustrated embodiment, NGFS 300 includes at least three status indicators LEDs, i.e., LED1, LED2, and LED3. In one example, LED1/LED2 may be used to indicate whether the flow rate of gas in a window of operation is below/above the center point of a tolerance band. LED3 may be used to indicate stable gas flow within the window of operation. The blinking frequency of each LED1 and LED2 may be changed to indicate the flow rate of gas approaches the center point of the tolerance band. These visual status indicators may be battery powered or AC powered with a DC adapter (e.g., 1212 shown in FIG. 12). The number of LEDs mounted on NGFS 300 is not limited to three. NGFS 300 may include a further visual indicator to indicate whether operational power is supplied to the NGFS 300.

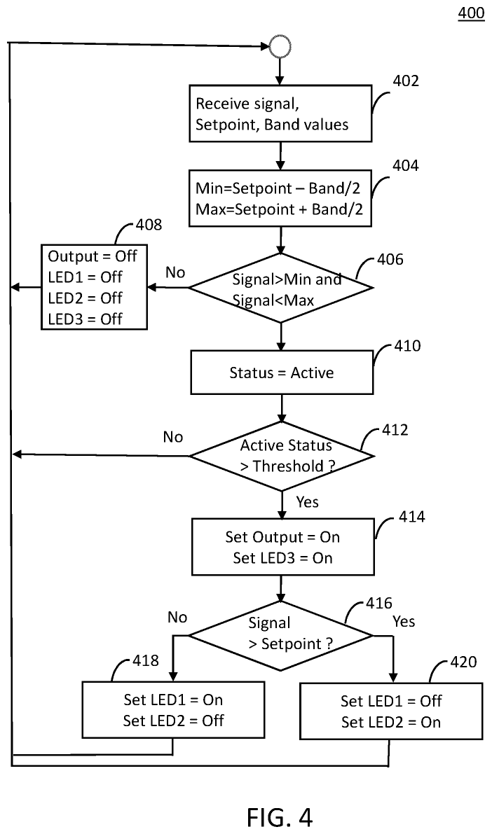

Gas flow evaluation processes are described with reference to FIGS. 4, 5, and 6. The processes (“400”, “500”, “600”) shown in FIGS. 4, 5, and 6 are implemented, for example, by NGFS 300 of FIG. 3. In these illustrated embodiments, LED1 is used as a low side indicator of a gas flow rate, LED2 is used as a high side indicator of a gas flow rate, and LED3 is used as an indicator indicative of stable gas flow within a window of operation.

Referring to FIG. 4, NGFS's processor (e.g., 110A of FIG. 3) receives, at step 402, a sensing signal (e.g., 108 of FIG. 3) indicative of a gas flow rate, Setpoint, and Band. “Setpoint” represents a center point of a tolerance band (e.g., 214 of FIG. 2B). “Band” represents the tolerance band (e.g., 216 of FIG. 2B). Using the Setpoint and Band values, the processor calculates, at step 404, two parameters: Min (=Setpoint−Band/2) and Max (=Setpoint+Band/2). “Min” represents a minimum flow rate (e.g., 204 of FIG. 2A) of the tolerance band. “Max” represents a maximum flow rate (e.g., 206 of FIG. 2A) of the tolerance band. The processor determines, at step 406, if the sensing signal indicates that the flow rate of gas is less than the maximum flow rate Max, but the flow rate of gas is greater than the minimum flow rate Min. If no, NGFS's output turns off, at step 408. In this illustrated embodiments, LED1, LED2 and LED3 turn off. The processor disables an active status to indicate that the gas flow rate is not within the window of operation defined by Min and Max. If yes, the processor enables the active status or holds the enabled active status if it has been already enabled, at step 410.

The processor monitors if the active status lasts more than a threshold time period. This threshold time period is, for example, but not limited to, 1.5 seconds. If no, the operation may go back to step 402. If yes, NGFS's output turns on, at step 414, which is indicative of stable gas flow rate within the window of operation. In this illustrated embodiment, LED3 turns on.

In the case where LED3 is on, the processor compares, at step 416, the Setpoint with the current gas flow rate indicated by the sensing signal, and determines whether the gas flow rate is greater than the Setpoint. The processor may calculate the average flow rate and compare the average flow rate with the Setpoint. If no, LED1 turns on and LED2 turns off, at step 418. If yes, LED1 turns off and LED2 turns on, at step 420. After each of steps 418 and 420, the operation may go back to step 402.

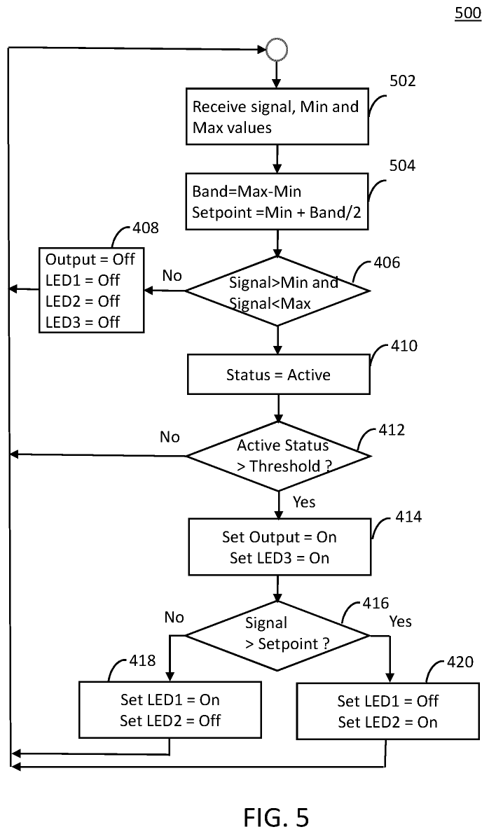

Referring to FIG. 5, NGFS's processor receives, at step 502, a sensing signal indicative of a gas flow rate (e.g., 108 of FIG. 3), a minimum flow rate Min (e.g., 204 of FIG. 2A) of a tolerance band, and a maximum flow rate Max (e.g., 206 of FIG. 2A) of the tolerance band. Using the Min and Max values, the processor calculates, at step 504, two parameters: Band (=Max−Min) and Setpoint (=Min+Band/2). “Band” represents a tolerance band (e.g., 216 of FIG. 2B). “Setpoint” represents a center point of the tolerance band (e.g., 214 of FIG. 2B). The processor then goes to step 406 and analyzes the gas flow rate, as described above in the process 400 of FIG. 4.

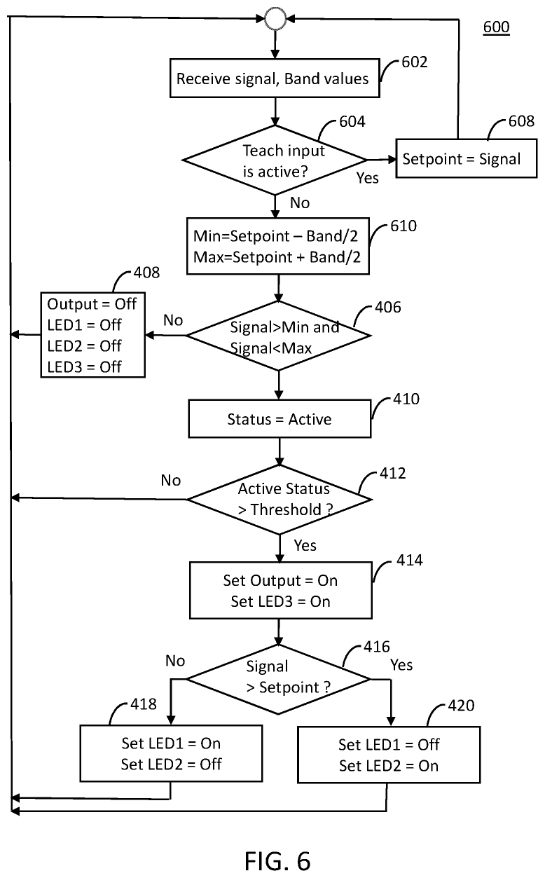

Referring to FIG. 6, the processor receives, at step 602 a sensing signal (e.g., 108 of FIG. 3), indicative of a gas flow rate and Band. “Band” represents a tolerance band (e.g., 216 of FIG. 2B). The processor determines, at step 604, whether a teach input (e.g., 114 of FIG. 3) is active. If yes, the gas flow rate is set as a Setpoint at step 606. “Setpoint” represents a center point of the tolerance band (e.g., 214 of FIG. 2B). Following step 606, the operation goes back to step 602. If no, the processor calculates, at step 608, two parameters: Min (a minimum flow rate of the tolerance band=Setpoint−Band/2) and Max (a maximum flow rate of the tolerance band=Setpoint+Band/2). The processor then goes to step 406 and analyzes the gas flow rate, as described above in the process 400 of FIG. 4.

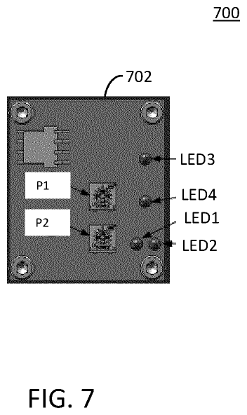

Referring to FIG. 7, a controller 700 for NGFS is described in detail. The controller 700 is similar to the controller 300 shown in FIG. 3. The controller 700 is a sensor board that is capable of communicating with a sensing element (e.g., 102 of FIGS. 1 and 3) and external equipment. The controller 700 receives one or more teach inputs (e.g., 114 of FIG. 3). The controller 700 outputs evaluation signals (e.g., 112 of FIG. 3), for example, including an output signal (e.g., an On/Off+24V signal) indicative of stable gas flow within a window of operation. The controller 700 may be configured to implement the process 400, 500, or 600 shown in FIGS. 4, 5, and 6.

The controller 700 has visual indicators LED1, LED2, and LED3, each being used in analyzing a gas flow rate read by the sensing element and evaluating stability of the gas flow. For example, LED1 is off in the case where 0<the gas flow rate<the minimum flow rate Min of the tolerance band in a window of operation. In one example, LED1 begins to blink when the gas flow rate goes to or above the minimum flow rate Min. As the gas flow rate approaches the setpoint from low to high, LED1 blinks faster. LED1 turns off when the gas flow rate exceeds the setpoint. LED2 acts similarly to LED1. LED2 is off in the case the gas flow rate is>0 and above the predetermined maximum flow rate Max. LED2 begins to blink when the gas flow rate goes to or below the maximum flow rate Max. As the gas flow approaches the setpoint from high to low, LED 2 blinks faster. LED2 turns off when the gas flow rate is less than the setpoint. When the gas flow rate is in the setpoint, LED1 and LED2 blink fast and at an equal rate. These operations may be combined with the processes 400, 500, and 600 of FIGS. 4, 5, and 6. The controller 700 may further include one or more additional LEDs (e.g., LED4). For example, LED 4 may indicate a status of operational power supply.

In one example, the controller 700 includes one or more manual adjustment members for adjusting parameters defining a window of operation. In this illustrated embodiment, the manual adjustment members include potentiometer knobs, P1, P2 (hereinafter referred to as “pot P1”, “pot P2”). In one example, pot P1 may be used to adjust the minimum flow rate (e.g., 204 of FIG. 2A) and pot P2 may be used to adjust the maximum flow rate (e.g., 206 of FIG. 2A). In order for the adjustment, the user/operator may turn pot P1 clockwise or counterclockwise and/or turn pot P2 clockwise or counterclockwise. In another example, pot P1 may be used to adjust the center point (e.g., 214 of FIG. 2B) of the window of operation, and pot P2 may be used to adjust the tolerance band (e.g., 216 of FIG. 2B) of the window of operation. These manual adjustments by pot P1 and/or pot P2 may be available during the evaluation processes 400, 500, and 600 shown in FIGS. 4, 5, and 6. The manual adjustment members for adjusting parameters of a window of operation are not limited to pots, P1, P2, which may include one or more manual push or pull buttons or other tools.

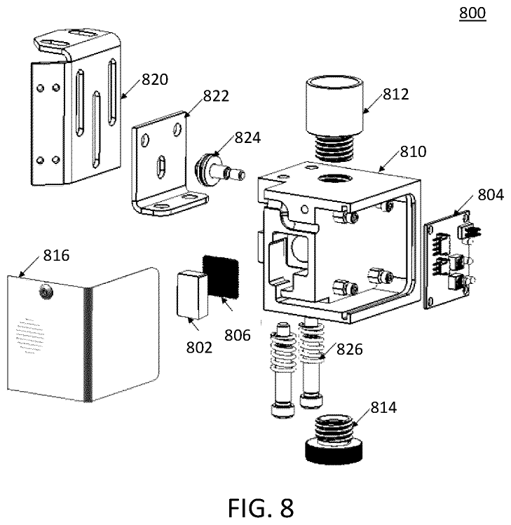

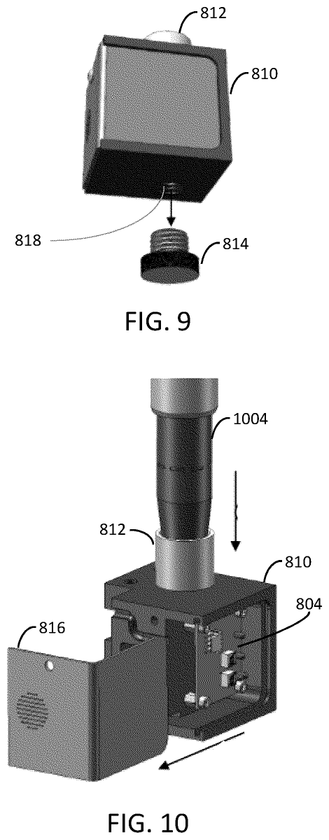

Referring to FIGS. 8, 9 and 10, NGFS 800 is described in detail. NGFS 800 has a housing in which a sensing element 802 and a controller 804 are accommodated. In this illustrated embodiment, the controller 804 may be same as the controller 700 shown in FIG. 7, and the sensing element 802 may be the sensing element 102 of FIGS. 1 and 3. The sensing element 802 and the controller 804 mounted on a main body 810 of the housing. A side plate 816 may be provided to cover the sensing element 802 and the controller 804. The main body 810 has an inner open space to which a gas flow is ejected. A flow cone 812 may be attached to the main body 810 to receive a front end of a gas nozzle for welding/cutting/spraying so that the front end of the nozzle is appropriately positioned with respect to the sensing element 802 when the sensing element 802 is installed. The gas nozzle may be manually positioned in the flow cone 812. The gas nozzle or NGFS 800 may be automatically positioned with respect to each other by fully or semi-automation equipment, e.g., a robot. The sensing element 802 and a replaceable filter 806 may be placed within a side hole (hollow space) in the main body 810, which is coupled to the inner open space of the main body 810. The filter 806 may be a mesh filter screen for separating debris or spatter from gas flow from a gas nozzle.

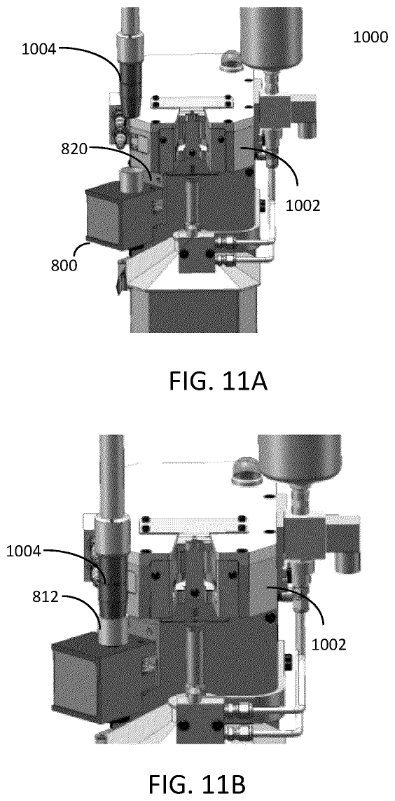

The housing may have a mounting bracket 820 and an adapter plate 822 for detachably attaching the main body 810 to external equipment (e.g. 1000 of FIGS. 11A and 11B). A roll spring assembly 824 and a vertical spring assembly 826 may be provided to create a soft movement of the housing. Movement in the same axis as a shoulder bolt of the roll spring assembly 814 as well as movement in the axis of the vertical spring assembly 826 will allow a robot or a machine to move the torch nozzle to make contact between the nozzle and the flow cone 812 without triggering an alert from a sensor(s) (e.g., a servo feedback sensor) typically indicative of collisions.

A drain plug 814 may be provided to close and open an aperture 818 connected to the inner open space. During the operation, the aperture 818 is closed by a drain plug 814. Any debris or spatter in the inner open space of the main body 810 may fall into the drain plug 814. For maintenance of NGFS, the drain plug 814 is removed and cleaned up. The inner open space also may be cleaned up through the aperture 818.

Referring to FIGS. 8-10, 11A and 11B, NGFS 800 may be installed onto robotic equipment 1000 where the motion of the welding torch is controlled using a programmable controller. The robotic equipment 1000 may be as a torch cleaner or reamer. The robotic equipment 1000 has a clamp assembly 1002 to hold a nozzle 1004. The robotic equipment 1000 may include means for cleaning the nozzle 1004, such as a brush, a reamer, high pressure air/fluid/spray, grinding or milling means, or other cleaning tools. The clamp assembly 1002 has a gripper head, and the mounting bracket 820 may be mounted on the gripping head. NGFS 800 may communicate with a control module of the robotic equipment 1000.

Referring to FIGS. FIGS. 8-10, 11A and 11B, one example of a setup procedure for NGFS 800 is described. In this example, pot P1 is a window center pot, and pot P2 is a window span pot. The setup procedure includes:

1. Move the robot 1000 to bring the nozzle 1004 to the target position with the nozzle fully engaged in the flow cone 812.

2. Remove the side plate 816 to expose the circuit board.

3. Check for sensor power supply on (LED4 is ON).

4. Adjust the window span pot P2 to maximum (e.g., fully clockwise). The window span pot may be adjusted by using, for example, a small flat or star screwdriver.

5. Turn on gas flow through the nozzle 1000 at desired flow rate.

6. Adjust the window center pot P1 until LED1 and LED2 are flashing equally. If LED1 is flashing alone, turn P1 9 e.g., clockwise), if LED2 is flashing alone, turn P1 (e.g., counterclockwise). The window center pot P1 may be adjusted by using, for example, a small flat or star screwdriver.

7. Check for output signal active (LED3 is ON).

8. Adjust the window span pot P2 to desired window span, check that the output signal remains active (LED3 is ON).

9. Turn off gas flow.

10. Check that the output signal deactivates (LED3 is OFF) and the high side and low side LEDS (LED1, LED2) are also off.

11. Move the robot 1000 to bring the out of the flow cone 812 to the approach position.

Referring to FIG. 12, there is provided an exemplary combination of a torch 1200 and NGFS 1210. The torch 1200 is configured to be used in automatic, semi-automatic or manual operations for welding, cutting, and/or spraying. The torch 1200 may be coupled to a power source 1202 for generating an arc and a gas source 1204 for generating shielding gas flow. NGFS 1210 may correspond to NGFS 100 shown in FIG. 1, NGFS 300 shown in FIG. 3, NGFS 800 shown in FIG. 8. NGFS 1210 may be coupled to a power source 1212 for various operations implemented in NGFA 1210.

In the above described embodiments, components as being “coupled” to one another may be directly joined or indirectly joined along one or more intervening elements (e.g., interfaces, tools and/or devices).

In some of the embodiments, certain functionality of a given element described herein (e.g., the controllers 104, 104A) may be implemented as pre-programmed hardware or firmware components (e.g., application specific integrated circuits (ASICs), electrically erasable programmable read-only memories (EEPROMs), etc.) or other related components. In other embodiments, a given element described herein (e.g., the controllers 104, 104A) may comprise a memory which stores program instructions for execution by the processor to implement certain functionality of that given element. The program instructions may be stored on data storage media that is fixed, tangible, and readable directly by the processor. The data storage media may store data optically (e.g., an optical disk such as a CD-ROM or a DVD), magnetically (e.g., a hard disk drive, a removable diskette), electrically (e.g., semiconductor memory, floating-gate transistor memory, etc.), and/or in various other ways. Alternatively, the program instructions may be stored remotely but transmittable to the given element via a modem or other interface device connected to a network over a transmission medium. The transmission medium may be either a tangible medium (e.g., optical or analog communications lines) or a medium implemented using wireless techniques (e.g., microwave, infrared or other wireless transmission schemes).

While the above description provides the exemplary embodiments, it is to be understood that the invention is not limited to the disclosed embodiments. Numerous modifications and variations of the present invention are possible in light of the above teachings. It is therefore to be understood that within the scope of the appended claims, the invention may be practiced otherwise than as specifically described herein. For example, the various elements or components may be combined or integrated in another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure.

1. A nozzle gas flow sensor, comprising:
circuitry configured to:
receive sensor readings from a sensing element, each reading indicative of a flow rate of shielding gas ejected from a nozzle of a torch; and
evaluate stability of the flow rate of the shielding gas with a window of operation based on the sensor readings to output an evaluation result indicative of stable gas flow within the window of operation.

2. The nozzle gas flow sensor according to claim 1, comprising at least one of:
an indicator indicative of a status of the flow rate of shielding gas; and
an indicator indicative of supply of operational power to the nozzle gas flow sensor.

3. The nozzle gas flow sensor according to claim 1, wherein the window of operation comprises one or more parameters, at least one of the one or more parameters being adjustable.

4. The nozzle gas flow sensor according to claim 1, wherein the window of operation is defined by at least a minimum flow rate, a maximum flow rate, a flow rate band between the minimum flow rate and the maximum flow rate, and/or a center point of the flow rate band, and wherein at least one of the minimum flow rate, the maximum flow rate, the flow rate band, and/or the center point of the flow rate band is adjustable.

5. The nozzle gas flow sensor according to claim 4, wherein the nozzle gas flow sensor is operated with at least one of the following:
a first manual operation member for adjusting the minimum flow rate;
a second manual operation member for adjusting the maximum flow rate;
a third manual operation member for adjusting the flow rate band; and/or
a fourth manual operation member for adjusting the center point of the flow rate band.

6. The nozzle gas flow sensor according to claim 4, wherein the circuitry is configured to:
compare the flow rate of the shielding gas with each of the minimum flow rate and the maximum flow rate; and
determine whether the following conditions (1) and (2) have continued at least for a threshold time frame:
(1) the flow rate of the shielding gas>the minimum flow rate;
(2) the flow rate of the shielding gas<the maximum flow rate.

7. The nozzle gas flow sensor according to claim 6, comprising:
an indicator indicative of stable gas flow within the window of operation, the indicator being enabled in the case where it is determined that the conditions (1) and (2) have continued at least for a threshold time frame.

8. The nozzle gas flow sensor according to claim 6, wherein the indicator comprises:
a first status indicator for indicating that the flow rate of the shielding gas is at or above the minimum flow rate within the window of operation; and/or
a second status indicator for indicating that the flow rate of the shielding gas is at or below the maximum flow rate within the window of operation.

9. The nozzle gas flow sensor according to claim 8, wherein at least one of the first status indicator and the second status indicator is a visual indicator, and wherein the circuitry is configured to control a blinking frequency of the visual indicator depending on a difference between the flow rate of the shielding gas and the center point of the flow rate band.

10. The nozzle gas flow sensor according to claim 4, wherein the circuitry is configured to:
determine the minimum flow rate and the maximum flow rate based on the flow rate band and the center point of the flow rate band.

11. The nozzle gas flow sensor according to claim 10, wherein the circuitry is configured to:
in response to a teach input, set the flow rate of the shielding gas read by the sensing element as the center point of the flow rate band.

12. The nozzle gas flow sensor according to claim 1, wherein the circuitry is configured to:
start analysis of the sensor reading at a predetermined timing.

13. The nozzle gas flow sensor according to claim 1, comprising:
a housing for accommodating at least one of the sensing element or the circuitry.

14. The nozzle gas flow sensor according to claim 1, comprising:
a receiving member for receiving the nozzle of the torch with respect to the sensing element.

15. The nozzle gas flow sensor according to claim 14, wherein the torch is a welding torch a cutting torch and/or a spraying torch, wherein the receiving member is detachably attached to a housing, and wherein the housing is installable onto welding, cutting, or spraying equipment.

16. The nozzle gas flow sensor according to claim 15, further comprising:
a spring member for creating a soft movement of the housing.

17. The nozzle gas flow sensor according to claim 13, wherein the sensing element is mounted on the housing to sense the flow rate of the shielding gas ejected to an inner space of the housing.

18. The nozzle gas flow sensor according to claim 17, comprising:
a removable filter mounted on the housing for filtering the debris to protect the sensing element.

19. The nozzle gas flow sensor according to claim 13, wherein the housing has a plug for removing debris from the inner space of the housing.

20. A method for a nozzle gas flow sensor, comprising:
receiving sensor readings from a sensing element, each said reading indicative of a flow rate of shielding gas ejected from a nozzle of a torch; and
evaluating stability of the flow rate of the shielding gas with a window of operation based on the sensor readings to output an evaluation result indicative of stable gas flow within the window of operation.

21. A method according to claim 20, comprising:
setting the window of operation.

22. A method according to claim 20, comprising:
comparing the flow rate of the shielding gas with each of a minimum flow rate and a maximum flow rate, the minimum flow rate and the maximum flow rate defining the window of operation; and
determining whether the following conditions (1) and (2) have continued at least for a threshold time frame:
(1) the flow rate of the shielding gas>the minimum flow rate;
(2) the flow rate of the shielding gas<the maximum flow rate.

23. A method according to claim 22, comprising:
operating on an indicator indicative of stable gas flow within the window of operation based on determination of whether the conditions (1) and (2) have continued at least for a threshold time frame.

24. A method according to claim 23, comprising:
operating on a first status indicator for indicating that the flow rate of the shielding gas is at or above the minimum flow rate within the window of operation; and/or
operating on a second status indicator for indicating that the flow rate of the shielding gas is at or below the maximum flow rate within the window of operation.

25. A method according to claim 23, comprising:
controlling a blinking frequency of the first status indicator depending on a difference between the flow rate of the shielding gas and a center point of a flow rate band between the minimum flow rate and the maximum flow rate.

26. A method according to claim 24, comprising:
controlling a blinking frequency of the second status indicator depending on a difference between the flow rate of the shielding gas and a center point of a flow rate band between the minimum flow rate and the maximum flow rate.

27. A method according to claim 23, comprising:
determining the minimum flow rate and the maximum flow rate based on a flow rate band between the minimum flow rate and the maximum flow rate and a center point of the flow rate band.

28. A method according to claim 27, comprising:
in response to a teach input, setting the flow rate of the shielding gas read by the sensing element as the center point of the flow rate band.

29. A method according to claim 20, comprising at least one of:
operating a visual indicator indicating the evaluation result;
actuating the sensing element;
starting analysis of the sensor reading at a predetermined timing;
supplying operational power to the sensing element, and
operating on an indicator for indicating the supply of the operational power.

30. A non-transitory computer readable medium storing instructions, which when executed by a computer cause the computer to execute a method that comprises:
receiving sensor readings from a sensing element, each said reading indicative of a flow rate of shielding gas ejected from a nozzle of a torch; and
evaluating stability of the flow rate of the shielding gas with a window of operation based on the sensor readings to output an evaluation result indicative of stable gas flow within the window of operation.
